(19) United States
(12) Patent Application Publication
(10) Pub. No.: US 2004/0059663 A1
(43) Pub. Date: Mar. 25, 2004

(54) System and method for conducting a hybrid auction

(76) Inventors: Joseph Herzog, Tel-Aviv (IL); Smadar Landav, Zichron Yakkov (IL)

Correspondence Address: Landon & Stock Associates, One Crystal Park, Suite 210, 2011 Crystal Dr., Arlington, VA, 22202-3709, US

(21) Appl. No.: 10/367,748

(22) Filed: Feb. 19, 2003

(30) Foreign Application Priority Data
Sep. 19, 2002 (IL) 151804

(51) Int. Cl. G06F 17/60

(52) U.S. Cl. 705/37

(57) ABSTRACT

Disclosed in this application, are various systems and methods for conducting a hybrid auction according to various embodiments of the present invention. According to some embodiments of the present invention, a posting module may post a service or product to be to auctioned at or below a maximum price, which maximum price may be below a market price of the service or product. An offer receiving subsystem may receive offers to buy the service or product, and an offer selection subsystem may select the highest unique received offer which is below the maxim price, any other non-unique offer correlated to the maximum price.

### RELATED PATENT APPLICATIONS

This Application claims priority under the Paris Convention from Israeli Patent Application No. 151,804, filed on Sep. 19, 2002.

### FIELD OF THE INVENTION

The present invention relates to the field of digital electronic commerce applications. More specifically, the present invention relates to a system and method for conducting a hybrid auction, wherein at least a portion of the to hybrid auction may be conducted in conjunction with a web site.

### BACKGROUND OF THE INVENTION

Auctions have been a part of human interactions since the first human societies formed on earth. Before there were any standardized currencies, bartering was used as a means of bidding on a desired object or service. The auction process has been refined considerably since the days of bartering for pigs, cow, humans, etc, as may be experienced in celebrated auction houses of our day such a Sothebys, and in the numerous capital markets around the world.

Although the processes of auctioning off a product or service have changed, evolved and been refined since the days of old, the goal of auctioning something off has remained fundamentally constant. That is, it is the goal of the party auctioning the item to obtain the best or highest value in return for the service or product being auctioned.

A variation of the conventional auction process, known as the “Reverse Auction,” as implemented on the Internet was patented and the patent was assigned to a company by the name of Walker Digital. The Reverse Auction process allows a prospective buyer to state what they are willing to pay for a service or product and several providers of the service or product are then given the chance to bid on providing that desired service or product. The prospective buyer is notified of the lowest available price for the desired service or product.

The largest and most successful implementation of the Reverse Auction model was done on the Internet. Few will argue that the Internet has revolutionized the means and the formats by which human beings communicate and conduct commercial transactions Walker Digital launched a Reverse Auction site by the name of www.priceline.com, which has become tremendously popular and has experienced a good level of commercial success.

The benefits of the Reverse Auction model according to priceline.com are clear. A prospective buyer is able to get the best price possible for a desired service or product and the vendors of such a service or product are able to sell excess inventory through a secondary and confidential distribution channel.

The reverse auction model of Walker Digital, however, requires that each time a prospective buyer states a price they are willing to pay for a service or product, a group of vendors of the given service or product are polled and asked to respond. This posses a logistic burden on the Reverse Auction organizer and on vendors themselves. If a large number of prospective buyers continue to state prices which are unrealistically low, the Reverse Auction organizer and the vendors are likely to spend a considerable amount of time engaging in futile activities.

A further drawback of the mode is that the prospective buyer has to wait some period of time before they are informed of whether a vendor has accepted their offer. In the event that no vendor has provided them with an offer, they must wait for notification before stating another price which they are willing to pay. This wait Introduces inefficiencies into the prospective transaction, and takes away from the excitement and emotional gratification usually associated with conventional auctions.

It would therefore be desirable to have a hybrid auction system and method by which potential buyers of a service or product are able to compete with each other for a product or service which the winner may then have the right to acquire at a substantially below market price.

### SUMMARY OF THE INVENTION

According to some embodiments of the present invention, there are various systems and methods for conducting a hybrid auction. According to some embodiments of the present invention, a posting module may post a service or product to be auctioned at or below a maximum price, which maximum price may be below a market price of the service or product. An offer receiving subsystem may receive offers to buy the service or product, and an offer selection subsystem may select an offer which is correlated to the maxim price. According to some embodiments of the present invention, an offer selection subsystem may select the highest unique offer below the to maximum price. According to other embodiments of the present invention the offer selection subsystem may select some unique or non-unique offer somehow correlated to a price of the service or product being auctioned.

According to some embodiments of the present invention, the offer receiving subsystem may be a computer application accessible to a prospective buyer through a computer network. According to other embodiments of the present invention, the offer receiving subsystem may be a telephone network.

According to some embodiments of the present invention, the offer selection subsystem may be a computer application to compare received offers and to select one or more offers correlated to a price of the service or product being auctioned. In other embodiments of the present invention, the offer selection subsystem may be an algorithm to select the highest unique received offer below the maxim price, which algorithm may be implemented either using a computer application or by using manual recording and comparing of data on paper or on a computer database.

### BRIEF DESCRIPTION OF THE DRAWINGS

The subject matter regarded as the invention is particularly pointed out and distinctly claimed in the concluding portion of the specification. The invention, however, both as to organization- and method of operation, together with containers, features, and advantages thereof, may best be understood by reference to the following detailed description when read with the accompanying drawings in which:

FIG. 1 Shows a flow diagram of the steps of a method by which some embodiments of the hybrid auction system of the present invention may be implemented;

FIG. 2 Shows a diagram of an Internet and Telephony based communication system including several communication options/paths by which some embodiments of the hybrid auction of the present invention may be implemented;

FIG. 3 Shows a diagram of a communication and computing segment including several servers upon which a posting module, an offer receiving subsystem, and an offer selection subsystem may be implemented according to some embodiments of the present invention; and

FIG. 4; Shows a block diagram illustrating a possible relationship between a posting module, an offer receiving subsystem, an offer selection subsystem and a sales/fulfillment system for a hybrid auction according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements,

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EEPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

According to some embodiments of the present invention, there are various systems and methods for conducting a hybrid auction. According to some embodiments of the present invention, a posting module may post a service or product to be auctioned at or below a maximum price, which maximum price may be below a market price of the service or product. An offer receiving subsystem may receive offers to buy the service or product, and an offer selection subsystem may select an offer which is correlated to the maxim price. According to some embodiments of the present invention, an offer selection subsystem may select the highest unique offer below the maximum price. According to other embodiments of the present invention the offer selection subsystem may select some unique or non-unique offer somehow correlated to a price of the service or product being auctioned.

According to some embodiments of the present invention, the offer receiving subsystem may be a computer application accessible to a prospective buyer through a computer network. According to other embodiments of the present invention, the offer receiving subsystem may be a telephone network.

According to some embodiments of the present invention, the offer selection subsystem may be a computer application to compare received offers and to select one or more offers correlated to a price of the service or product being auctioned. In other embodiments of the present invention, the offer selection subsystem may be an algorithm to select the highest unique received offer below the maxim price, which algorithm may be implemented either using a computer application or by using manual recording and comparing of data on paper or on a computer database.

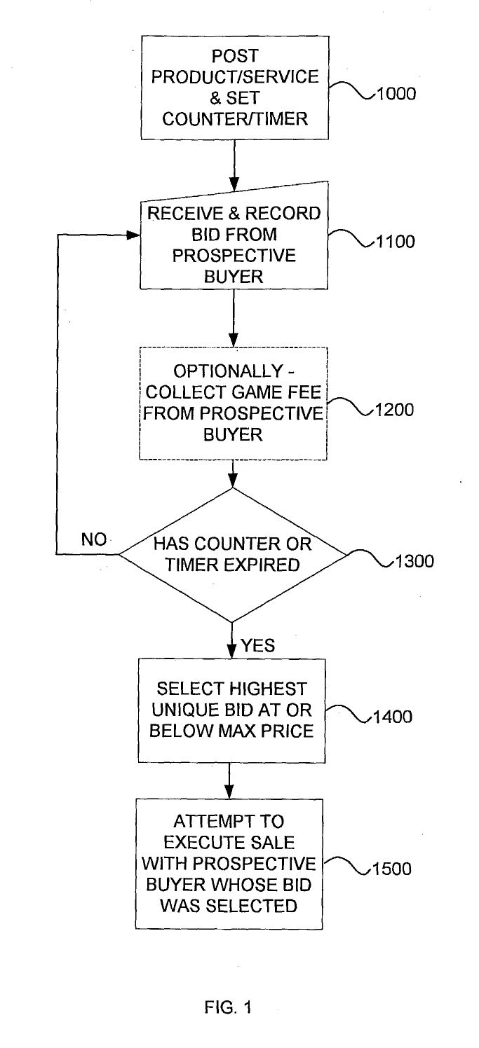

Turning now to FIG. 1, there is shown a flow diagram of with the steps of a method by which a hybrid auction system according to some the present invention may be implemented. As in most auctions, a product or service (“item”) to be auctioned off is presented or posted to a group of prospective buyers or bidders (Step1000). In the context of an Internet or print based auctioning, the term posting may mean publishing the item on a website or on some tangible form of print. In the context of a live auction, the terms presenting or posting may simply mean notifying prospective buyers or bidders of the item's availability.

According to some embodiments of the present invention, along with the posting of the item, a maximum allowable price may also be posted. That is, according to some embodiments of the present invention, prospective buyers are only allowed to bid amounts up to a maximum limit. According to some embodiments of the present invention, the maximum allowable price (“MaxPrice”) may be some percentage of the market value of the item. According to the present day best mode of the present invention, an item's MaxPrice may be no greater than 50% of the item's fair market value.

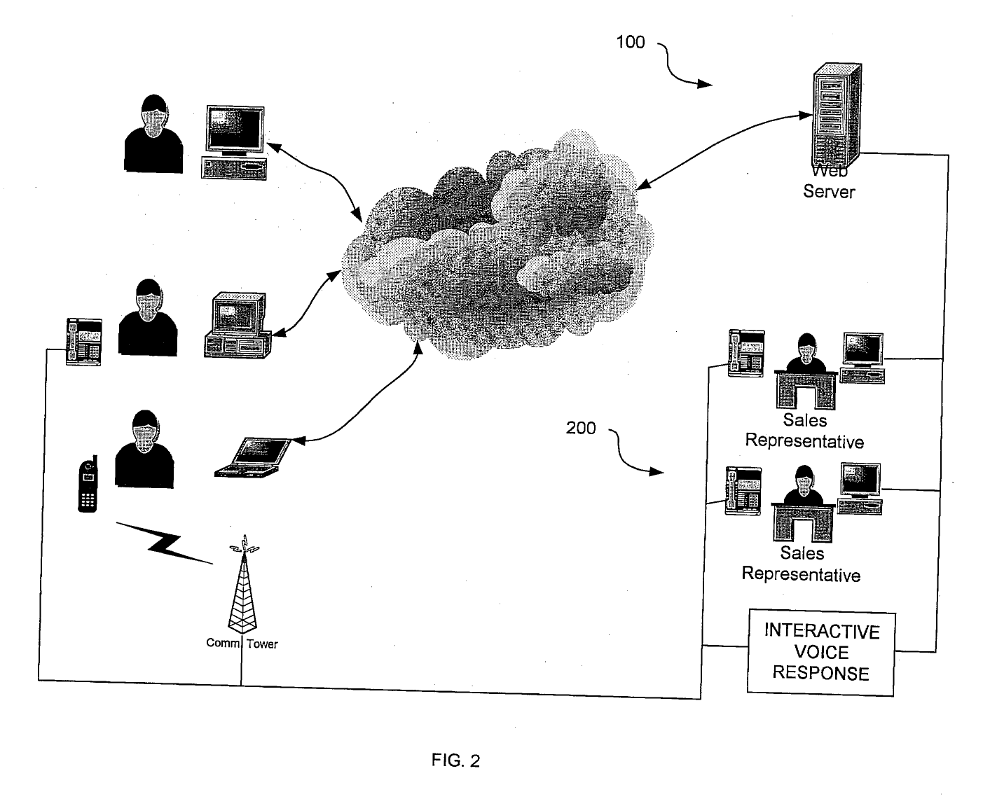

FIG. 2 shows a diagram of an Internet and Telephony based communication system having several communication options by which some embodiments of a hybrid auction according to the present invention may be implemented. In the context of an Internet based auction system, a hybrid auction system and method according to some embodiments of the present invention may utilize a web server 100 connected to the public Internet, which web server may be accessed by prospective buyers of bidders. Items, along with their MaxPrice, may be posted on a website associated with the web server. As part of a hybrid auction, practiced in accordance with some embodiments of the present invention, multiple items may be posted concurrently to a website.

A posting module is a term which refers to any system or application used to post an item either to the Internet or to print. With respect to FIG. 2, the posting module would be a server application running on the web server 100. Posting module may also refer to any computer application used to update data presented by a server application running on the web server of FIG. 2.

Turning back to FIG. 1, there is shown that once an item has been posted, along with the item's MaxPrice, offers or bids from a group of prospective buyers or bidders may be received and recorded (Step 1100) through an offer/bid receiving subsystem (FIG. 2, 200). As visible from FIG. 2, offers may be received over a Telephony network by one or more live operators or though an Interactive Voice Response (“IVR”) Systems. A prospective buyer or bidder, having seen a posted item, may call a sales representative associated with a hybrid auction and may make an offer or a bid on the item posted. According to a best mode of the present invention, only bids at or below an item's MaxPrice may be recorded.

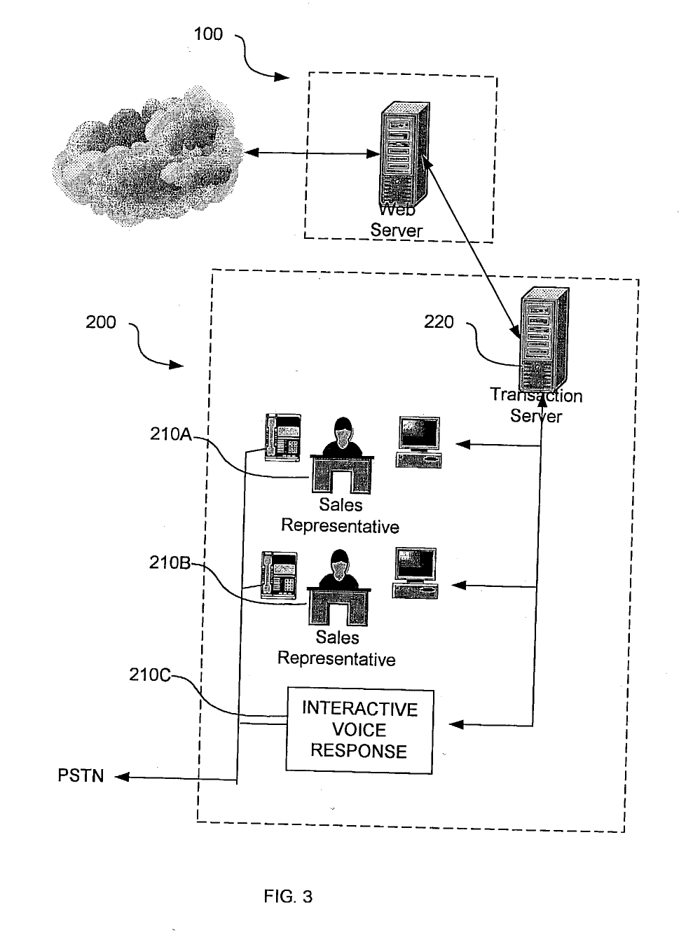

FIG. 3 shows a diagram of a communication and computing segment including several servers upon which a posting module, an offer receiving subsystem, and an offer selection subsystem may be implemented according to some embodiments of the present invention. According to some Internet based implementations of the present invention, a prospective buyer or bidder may make an offer through a website on which the posting occurred. The website may be on a web server 100 connected to a transaction server 220 running an application adapted to receive and record offers or bids. In some embodiments of the present invention, prospective buyers may either use the internet to enter an offer into a transaction server or may contact a sales representative by phone 210A or 201B, which sales representative 210 may in turn enter the offer or bid into the transaction server 220. The use of computer and web based form filling is well known. Any such technology available today or to be devised in the future is applicable to the present invention.

Turning back to FIG. 1, there is seen that in connection with receiving an offer or bid for a posted item, a fee may be collected from the prospective buyer or bidder (Step 1200). The fee may be collected by credit card or by any other payment means known today or to be devised in the future. With the payment or fee, personal information (e.g. address, telephone, age, sex, etc. . . . ) may be collected on the party who submitted an offer. This information may be used to determine a person's eligibility for a given item and may also be used to insure consummation or enforcement of a sale in the event the prospective buyer or bidder has submitted a winning bid.

According to some embodiments of the present invention, shortly after a person submits an offer or a bid through an offer receiving subsystem according to some embodiments of the present invention, the person may also be able to check whether their bid is the highest unique bid below the MaxPrice (ie. a winning bid) of the item. A person who has submitted an offer or bid may check the status of the offer or bid either over the phone or through a website associated with the hybrid auction. A posting module according to some embodiments of the present invention may provide offer status data, in addition to simply posting items. According to some embodiments of the present invention, a prospective buyer or bidder may change the value of the offer made on an item (Step 1100).

Each time an item is posted, either a timer or a counter may be set (Step 1000). That is, for each time, there may either be a fixed period of time or a fixed number of offers which may be accepted before a winning offer is selected for the item. Thus, after an offer is received, either the timer or the counter may be checked (Step 1300) to see whether to close the auction and to select a winning offer.

For example, it when an item is posted a two day timer is set, after the two days passes, the auction is closed and all offers received before the close may be reviewed by an offer selection subsystem determine which is the highest unique offer below the item's MaxPrice. On the other hand, if when an item is posted a counter is set to a predefined number of offers, after the predefined number of offers is received, the auction may be closed regardless of the period of time the item was on auction (e.g. 2 hours or 2 months). According to some embodiments of the present invention, a combination of a counter and timer may be used. That is, a hybrid auction according to some embodiments of the present invention may close either at the expiration of a timer or after a predefined number of offers is received.

Once it is determined that either the term of the auction or the number of offers has reached some predefined limit, an offer-selection subsystem may receive all the offers submitted for a given item and may determine, the winning offer (Step 1400). An offer selection subsystem may be implemented using a computer application running on the transaction server 220 of FIG. 3, or on an application running on an associated computer. Such data querying and selection applications are well known. Furthermore, an offer selection subsystem may be implemented using a manual auditing systems and procedures to review all recorded offers and to determine which offer qualifies as a winning offer or bid under the rules of the hybrid auction.

In a best mode of the present invention, as exemplified in FIG. 1, a winning offer or bid may be selected as the highest unique offer below the MaxPrice. However, one of ordinary skill in the art would understand that the criteria for a winning bid may be arbitrarily modified. For example, instead of the winning bid being the highest unique bid below an item's MaxPrice, a winning bid may be defined as the second or third highest unique bid. Furthermore, the winning bid may even be defined as the closest unique bid to an item's MaxPrice, regardless of whether the bid is either above or below the MaxPrice.

According to some embodiments of the present invention, the winning bid for an item may be defined as a non-unique (e.g. at least two people made the same offer) bid, where the number of people making the same bid and the value of the offer are somehow correlated to an item's posted MaxPrice. For example, the winning bid may be defined as the second highest bid below the MaxPrice, on which bid at least two (three, four, etc.) bidders made the same offer. The winning bid may also be defined as the closest offer to the MaxPrice, either above or below the MaxPrice, on which exactly two bidders made the same bid. In non-unique bid situations, each of the winning bidders may be qualified to purchase the item either at the MaxPrice or at the price they offered (Step 1500).

The rules for selecting a winning offer or set of offers for an item may be set during the posting of an item. In the event the rules for a winning bid on a given item do not require that the winning bid(s) be below a maximum price, the term MaxPrice may mean a “target price” rather than a maximum price.

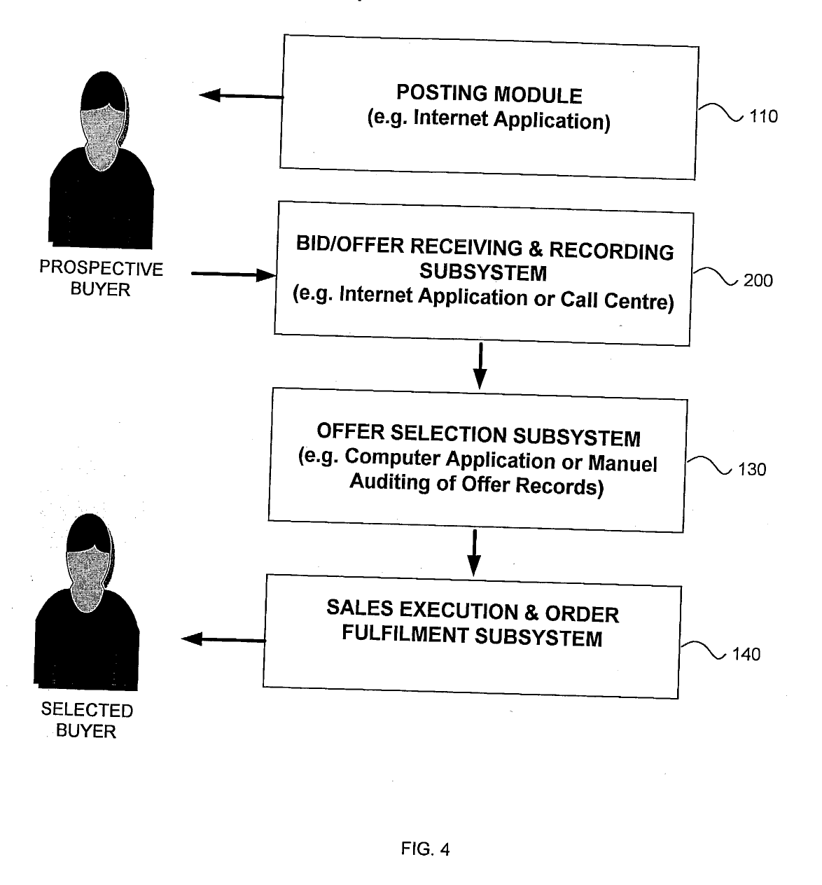

Turning now to FIG. 4, there is shown a block diagram illustrating a possible relationship between the posting module 110, the offer receiving subsystem 200, the offer selection subsystem 130 and a fulfillment system 140 for a hybrid auction according to some embodiments of the present invention. The posting module 110 is used to notify prospective buyers or bidders of an item up for auction and a MaxPrice associated with the item. The offer receiving subsystem 200 may receive offers from prospective buyers. The offer selection subsystem 130, once the auction is closed, may select a winning bid based some predefined rules relating the MaxPrice. Upon selecting a winning bid for an item, a sales execution and order fulfillment system 140 may close the sale of the item with the winning bidder(s) and may facilitate the delivery of the item. As mentioned above the sales price of the item may either be the MaxPrice, the winning bid, or some formula based on either one.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A method of conducting a hybrid auction comprising:
offering a product or service to one or more prospective buyers at a maximum price which is below a market price;
receiving offers to buy the product from the one or more prospective buyers; and
accepting the offer with is correlated to the maximum price.

2. The method according to claim 1, wherein the step of accepting comprises accepting the highest unique offer which is the same or below the maximum price.

3. The method according to claim 1, further comprising receiving a registration fee amount from each prospective buyer.

4. The method according to claim 2, wherein the registration fee amount is directly related to a difference between the maximum price and the market price of the product or service.

5. The method according to claim 1, further comprising notifying a prospective buyer whether their offer is unique.

6. The method according to claim 4, receiving a changed offer from a prospective a buyer who has been notified their offer was not unique.

7. The method according to claim 1, further comprising selling the product or service to the prospective buyer whose offer was accepted.

8. A system for conducting a hybrid auction comprising:
a posting module to post a service or product to be to auctioned at or below a maximum price which is below a market price of the service or product;
an offer receiving subsystem to receive offers to buy the service or product at or below the maximum price; and
an offer selection subsystem to select a received offer for the service or product which is correlated to the maximum price.

9. The system according to claim 8, wherein said offer selection subsystem is adapted to select a received offer for the service or product which is the highest unique offer below the maxim price.

10. The system according to claim 9, wherein said offer receiving subsystem is comprised of a computer application accessible to a prospective buyer through a computer network.

11. The system according to claim 9, wherein said offer selection subsystem is a computer application to compare received offers and to select the highest unique offer below the maxim price.

12. The system according to claim 9, wherein the offer receiving subsystem is comprised of a telephone network.
